(19) United States
(12) Patent Application Publication
(10) Pub. No.: US 2014/0084684 A1
(43) Pub. Date: Mar. 27, 2014

(54) POWER SUPPLY CIRCUIT

(71) Applicant: Nien-Hui Kung, Hsinchu-City (TW)

(72) Inventor: Nien-Hui Kung, Hsinchu-City (TW)

(73) Assignee: Richtek Technology Corporation

(21) Appl. No.: 13/624,758

(22) Filed: Sep. 21, 2012

(51) Int. Cl. H02J 1/00

(52) U.S. Cl. 307/19

(57) ABSTRACT

The present invention provides a power supply circuit, which includes a plurality of switchable bidirectional regulators, respectively coupled between a first common node and a plurality of external terminals, and each external terminal has a switchable connection selectively electrically connectable to a external power source for receiving power supply from the external power source or to an external device for charging the external device. Each switchable bidirectional regulator includes: an upper power transistor switch, a lower power transistor switch, an inductor, and a buck-boost controller for controlling operations of the upper power transistor switch and the lower power transistor switch to perform either buck or boost voltage conversion according to a mode control signal.

### BACKGROUND OF THE INVENTION

1. Field of Invention

The present invention relates to a power supply circuit having plural switchable bidirectional regulators capable of supplying power to a common node and at least one external terminal.

2. Description of Related Art

Products with charging function usually include multiple input/output power source terminals; for example, a power bank can provide multiple power outputs, or a notebook PC can supply system power and multiple USB power outputs at the same time. FIG. 1 shows a prior art power supply circuit 10 which is capable of connecting to two external terminals Vin1 and Vin2, one of which supplies power to the system Vsys through a buck conversion circuit, while the other of which is charged from the system Vsys through a boost conversion circuit; the system Vsys can further charge a battery Vbat through a power transistor M6. The buck conversion circuit includes a buck controller 11 which controls the power transistors according to the connection conditions of the external terminals; for example, if the system Vsys is powered from the external terminal Vin1 through the buck conversion circuit, the buck controller 11 turns off the power transistor M2, and alternately switches on and off power transistors M1 and M3, to provide a buck-converted output voltage to the system Vsys. The boost conversion circuit includes a multiplexor 12 and a boost controller 13. The multiplexor 12 selects one of the external terminals Vin1 and Vin2; for example, if the external terminal Vin2 is charged from the system Vsys through the boost conversion circuit, then the multiplexor 12 will select the external terminal Vin2.

The prior art provides poor flexibility to a user because one of the two external terminals must be an input for buck conversion and the other must be an output for boost conversion; besides, three power transistors are needed in the buck conversion circuit and one multiplexor is needed in boost conversion circuit, so the related cost is high not cost effective.

Therefore, it is desired to simplify the prior art power supply circuit and improve its flexibility.

### SUMMARY OF THE INVENTION

The above and other objects and benefits of the present invention can be further understood from the disclosed technical features.

In one aspect, the present invention provides a power supply circuit, which includes a plurality of switchable bidirectional regulators respectively coupled between a first common node and a plurality of external terminals, and each external terminal has a switchable connection selectively electrically connectable to a external power source for receiving power supply from the external power source or to an external device for charging the external device. Each switchable bidirectional regulator includes: an upper power transistor switch, couple to the external terminal; a lower power transistor switch, coupled to the upper power transistor switch at a switch node; an inductor, having one terminal coupled to the upper power transistor switch and the lower power transistor switch at the switch node, and the other terminal coupled to the first common node; and a buck-boost controller, for controlling operations of the upper power transistor switch and the lower power transistor switch to perform either buck or boost voltage conversion, wherein the buck-boost controller receives a mode control signal which determines whether the switchable bidirectional regulator performs buck voltage conversion from the external terminal to the first common node or performs boost voltage conversion from the first common node to the external terminal.

In a preferable embodiment of the present invention, the switchable bidirectional regulator further includes a current sinking and sourcing judgment circuit for testing whether current can be drawn from the external terminal to generate the mode control signal determining whether the switchable bidirectional regulator performs buck voltage conversion or performs boost voltage.

In a preferable embodiment of the present invention, the power supply circuit further includes: a second common node; a power transistor, coupled between the first common node and the second common node; and a charge control unit, for controlling the power transistor to charge the second common node from the first common node.

In a preferable embodiment of the present invention, the charge control unit controls the charging to the second common node according to a voltage at the first common node.

In another preferable embodiment of the present invention, the charge control unit controls the charging to the second common node according to a voltage at the first common node, a voltage at the second common node, and a current through the power transistor.

In a preferable embodiment of the present invention, the power supply circuit further includes: a first error amplifier, for generating a first control signal according to a current through the power transistor and a first reference signal; and a second error amplifier, for generating a second control signal according to the voltage at the second common node and a second reference signal, wherein the buck-boost controller operates according to the first control signal and the second control signal when the switchable bidirectional regulator performs buck voltage conversion from the external terminal to the first common node.

In another preferable embodiment of the present invention, the power supply circuit further includes: a first error amplifier, generating a first control signal according to a voltage at the first common node and a first reference signal, wherein the buck-boost controller operates according to the first control signal when the switchable bidirectional regulator performs buck voltage conversion from the external terminal to the first common node.

In a preferable embodiment of the present invention, the switchable bidirectional regulator includes a third error amplifier, which generates a third control signal according to a voltage at the external terminal and a third reference signal, and the buck-boost controller operates according to the third control signal when the switchable bidirectional regulator performs boost voltage conversion from the first common node to the external terminal.

In a preferable embodiment of the present invention, at least one external terminal is coupled to an external power source, and at least another external terminal is coupled to an external device.

The objectives, technical details, features, and effects of the present invention will be better understood with regard to the detailed description of the embodiments below, with reference to the drawings.

### BRIEF DESCRIPTION OF THE DRAWINGS

FIG. 1 shows a prior art power supply circuit.

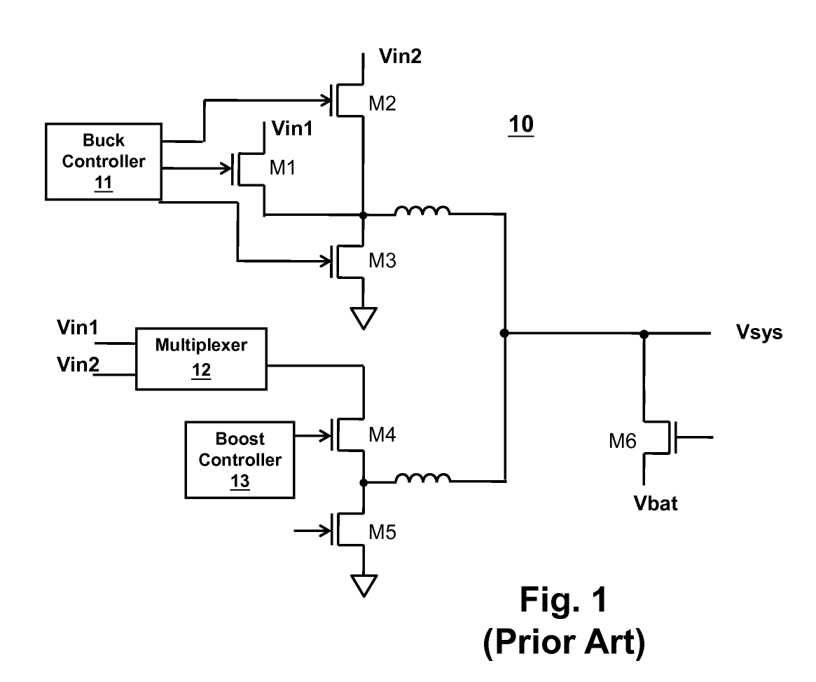

FIG. 2 shows a preferable embodiment of the power supply circuit according to the present invention.

FIG. 3 shows a preferable embodiment of the switchable bidirectional regulator according to the present invention.

FIG. 4 shows another preferable embodiment of the power supply circuit according to the present invention.

FIG. 5 shows another preferable embodiment of the switchable bidirectional regulator according to the present invention.

### DESCRIPTION OF THE PREFERRED EMBODIMENTS

The drawings as referred to throughout the description of the present invention are for illustrative purpose only, but not drawn according to actual scale. The orientation wordings in the description such as: top, bottom, left, or right are for reference to the drawings only, and not to restrict any orientation in an actual product.

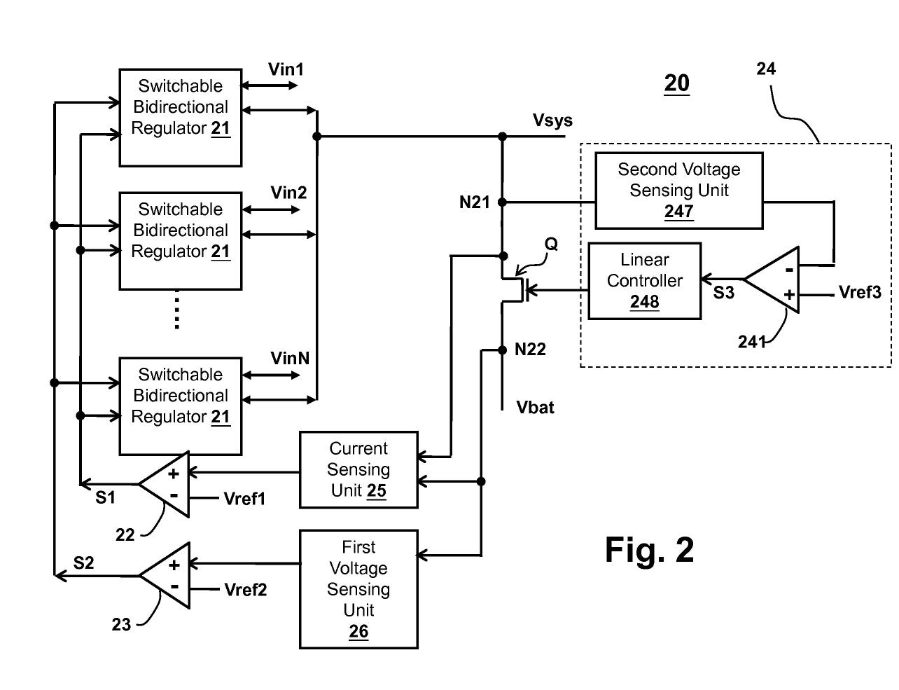

FIG. 2 shows an embodiment of a power supply circuit 20 according to the present invention. The power supply circuit 20 includes plural switchable bidirectional regulators 21, a first error amplifier 22, and a second error amplifier 23. If it is required to charge a battery Vbat from the system Vsys, the power supply circuit 20 can further include a power transistor Q and a charge control unit 24, wherein the charge control unit 24 includes a third error amplifier circuit 241 and a linear controller 248, and can optionally include a second voltage sensing unit 247. If it is not required to charge a battery Vbat from the system Vsys, the power transistor Q and charge control circuit 24 can be omitted.

Plural switchable bidirectional regulators are respectively coupled between a first common node N21 and external terminals Vin1, . . . , VinN, wherein the external terminals Vin1, . . . , VinN can each be coupled to an external power source for receiving power supply from the external power source, or can be coupled to an external device for charging the external device. That is, each external terminal Vin1, . . . , VinN is selectively electrically connectable to a external power source or an external device; the connection is switchable. For simplicity, it is assumed that Vin is coupled to an external power source and Vin2 is coupled to an external device in the following description, but the present invention is certainly not limited therein. In this embodiment, the system Vsys is capable of charging the battery Vbat, so the power transistor Q is coupled between a first common node N21 and a second common node N22, and it controls the charging to the second common node N22 according to the voltage at the first common node N21. For charging the battery Vbat, the circuit can include a current feedback control loop (to control the battery charging current in compliance with the specification), and a voltage feedback control loop (to determine whether the battery is fully charged and stop charging). The current feedback control can be done by comparing the current through the power transistor Q with a first reference signal Vref1, which is performed by the first error amplifier 22, to generate a first control signal S1 to feed-back control the switchable bidirectional regulator. In another embodiment where it is not required to charge a battery, the circuit loop does not need to retrieve the current information; or in yet another embodiment, the information of the current from the external terminal Vin1 to the system Vsys can be obtained, for the purpose such as over-current protection. The voltage feedback control for battery Vbat can be done by comparing the voltage at the common node N22 with a second reference signal Vref2, which is performed by a second error amplifier 23, to generate a second control signal S2 to feed-back control the switchable bidirectional regulator 21. The third error amplifier circuit 241 generates a control signal S3 according to the voltage at the first common node N21 and a third reference signal Vref3, to control the operation of the power transistor Q to charge the second common node N22.

In a preferable but not limiting embodiment of the present invention, the first error amplifier 22 can receive information of the current through the power transistor Q by a current sensing unit 25. The current sensing unit 25 sends a sensing result to the first error amplifier 22 and the first error amplifier 22 generates the first control signal S1 according to comparison between the current sensing result and the first reference signal Vref1, wherein the first reference signal Vref1 corresponds to a safe upper limit of the charging current, or a value which is set according to the design requirements. According to the first reference signal Vref1, the power supply circuit 20 can keep the charging current to the first common node 20 not to exceed the set value.

In a preferable but not limiting embodiment of the present invention, the second error amplifier 23 can receive information of the voltage at the second common node N22 by a first voltage sensing unit 26, and the first voltage sensing unit 26 sends the sensing result to the second error amplifier 23. The second error amplifier 23 generates the second control signal S2 according to comparison between the voltage sensing result and a second reference signal Vref2. The second reference signal Vref2 corresponds to a safe upper limit for the voltage of the battery Vbat, to keep the voltage of the battery not to exceed the safe value (or to determine whether the battery is fully charged). The second reference signal Vref2 can be set according to requirements.

In a preferable but not limiting embodiment of the present invention, the third error amplifier circuit 241 can receive information of the voltage at the first common node N21 by the second voltage sensing unit 247, and the second voltage sensing unit 247 sends the sensing result to the third error amplifier circuit 241. The third error amplifier circuit 241 generates the control signal S3 according to comparison between the voltage sensing result and a third reference signal Vref3, and the control signal S3 is sent to a linear controller 248 to control the power transistor Q for charging the second common node N22. The third reference signal Vref3 can be a value which is set according to the power supplying condition at the first common node N21. For example, it can be set so that when the voltage at the first common node N21 is higher than the third reference signal Vref3, the power transistor Q keeps the voltage difference between the first common node N21 and the second common node N22 within a specific range, the voltage difference being for example but not limited to the lowest source-drain voltage in the fully conduction status of the power transistor Q, so that the charging path from the first common node N21 to the second common node N22 has a lowest power consumption and optimum charging efficiency.

However, the voltage sensing units described in the above can be omitted, that is, the input of the error amplifier can be directly coupled to the corresponding voltage sensing node.

The feedback control loops described in the above are for controlling the power supply to the first common node N21 from the external terminal Vin1 (which is assumed to be coupled to external power source) and the charging to the second common node N22 from the first common node N21. If it is desired to charge an external device (which is assumed to be coupled to the external terminal Vin2), the voltage at the external terminal Vin2 can be fed back to control the operation of the switchable bidirectional regulator 21; in this case, each external terminal Vin1, . . . , VinN has a corresponding feedback control circuit. For illustrative purpose, the feedback control circuit according to the voltage at the external terminal is included in the switchable bidirectional regulator in FIG. 2, which will be explained later in the following description.

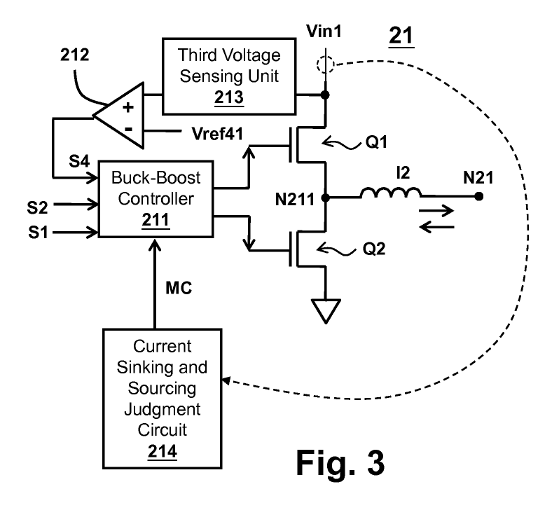

FIG. 3 shows an embodiment of the switchable bidirectional regulator 21. The switchable bidirectional regulator 21 for example includes a buck-boost controller 211, an upper transistor switch Q1, a lower transistor switch Q2, an inductor 12, and a fourth error amplifier 212; optionally, it can further include a third voltage sensing unit 213. The upper transistor switch Q1 has one end which is coupled to the external terminal Vin1, and another end which is coupled to the lower transistor switch Q2 at a third common node N211 (also named switch node). The upper transistor switch Q1 is coupled to the first common node N21 through the inductor 12, wherein the switchable bidirectional regulator 211 controls a buck or boost voltage conversion operation by turning on/off the upper transistor switch Q1 and the lower transistor switch Q2.

When the buck-boost controller 211 performs a buck voltage conversion (wherein power is supplied from the external terminal Vin1 to the first common node N21), the buck-boost controller 211 controls the operation of the upper transistor switch Q1 and the upper transistor switch Q2 according to the first control signal S1 and the second control signal S2. When the buck-boost controller 211 performs a boost voltage conversion (wherein the external terminal Vin1 is charged from the first common node N21), the buck-boost controller 211 controls the operation of the upper transistor switch Q1 and the upper transistor switch Q2 according to the fourth control signal S4. In one embodiment, the fourth error amplifier 212 receives information of the voltage at the external terminal 213 through a third voltage sensing unit 213, and the third voltage sensing unit 213 sends the sensing result to the fourth error amplifier 212. The fourth error amplifier 212 generates the fourth control signal S4 according to comparison between the voltage sensing result and a fourth reference signal Vref4.

In a preferable embodiment, the switchable bidirectional regulator 21 determines to perform a buck voltage conversion or a boost voltage conversion according to a mode control signal MC. The model control signal MC can be generated in various ways. For example, it can be inputted from an external circuit, inputted by a user, or determined according to an operation characteristic of the external terminal Vin1. An example of the latter is thus. The switchable bidirectional regulator 21 can include a current sinking and sourcing judgment circuit 214 for judging whether the external terminal is sinking or sourcing current. If the external terminal Vin1 is sinking current, it is determined that the external terminal Vin1 is coupled to an external device, while if the external terminal Vin1 is sourcing current, it is determined that the external terminal Vin1 is coupled to an external power source. The current sinking and sourcing judgment circuit 214 for example can test whether current can be drawn from the external terminal Vin1 and make a corresponding judgment. However, this is not the only way to do the judgment, and the current sinking and sourcing judgment circuit 214 is not necessarily required in the power supply circuit. Different types of external terminals have their own industrial specification, and a judgment of sinking or sourcing current can be made accordingly. Or, it is also practicable to switch the buck/boost mode by external control.

The buck-boost controller 211 can be a pulse width modulation controller or pulse frequency modulation controller; the details of such controllers are well-known and therefore omitted in the present invention.

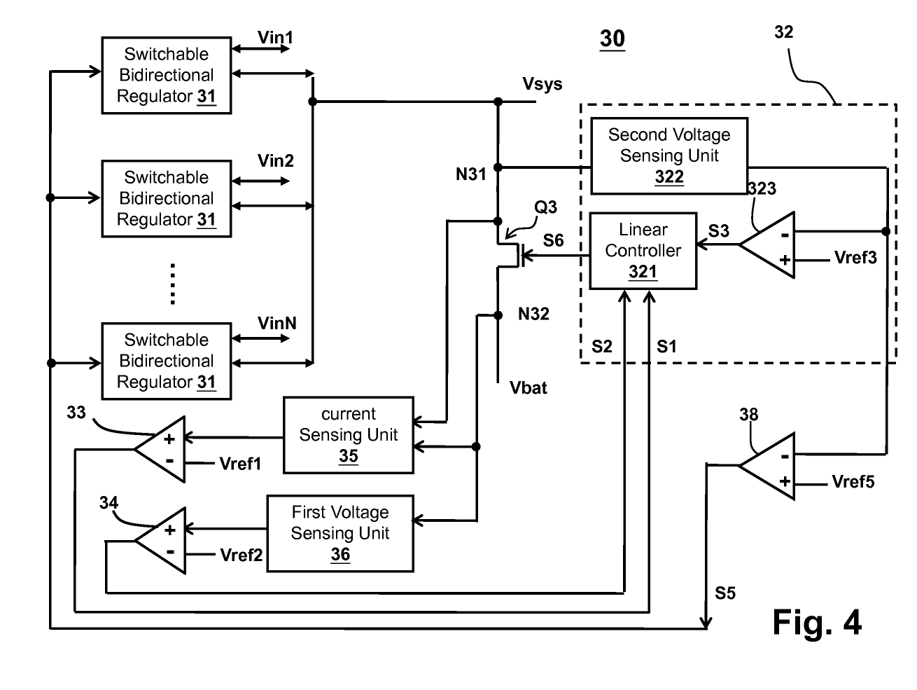

FIG. 4 shows another embodiment of the power supply circuit 30. The power supply circuit 30 includes plural switchable bidirectional regulators 31, a power transistor Q3, a charge control unit 32, a first error amplifier 33, a second error amplifier 34, and a third error amplifier circuit 38. The plural switchable bidirectional regulators 31 are respectively coupled between a first common node N31 and external terminals Vin1, . . . , VinN, wherein the external terminals Vin1, . . . , VinN can each be coupled to an external power source for receiving power supply from the external power source, or can be coupled to an external device for charging the external device. The power transistor Q3 is coupled between the first common node N31 and a second common node N32, for controlling charging to the second common node N32. The charge control circuit 32 controls the operation of the power transistor Q3. The details thereof will be described below.

The first error amplifier 33 generates a first control signal S1 according to the current through the power transistor Q3 and a first reference signal Vref1, and sends the first control signal S1 to the charge control unit 32, wherein the first error amplifier 33 for example can receive information of the current through the power transistor Q3 by a current sensing unit 35. The second error amplifier 34 generates a second control signal S2 according to the voltage at the second common node N32 and a second reference signal Vref2. The error amplifier 34 for example can receive information of the voltage at the second common node N32 by a first voltage sensing unit 36, and the first voltage sensing unit 36 sends the sensing result to the second error amplifier 34. The second error amplifier 34 generates the second control signal S2 according to comparison between the voltage sensing result and the second reference signal Vref2. The first reference signal Vref1 and the second reference signal Vref2 can be set by ways as described in the aforementioned embodiment.

In this embodiment, the charge control unit 32 includes a linear controller 321 and an error amplifier 323, and can optionally include a second voltage sensing unit 322. The linear controller 321 generates a control signal S6 according to the first control signal S1, the second control signal S2, and a control signal S3; the control signal S6 controls the power transistor Q3 for charging the second common node N32. The fourth error amplifier 323 generates the control signal S3 according to the voltage at the first common node N31 and a third reference signal Vref3, and sends the control signal S3 to the linear controller 321, wherein the information of the voltage at the first common node N31 for example can be obtained by a second voltage sensing unit 322. The third reference signal Vref3 can be set by ways as described in the aforementioned embodiment.

The function of the above control loop is: controlling the charging to the second common node N32 from the first common node N31 according to the voltages at the first common node N31 and the second common node N32, and the current through the power transistor Q3.

The third error amplifier circuit 38 generates a control signal S5 according to the voltage at the first common node N31 and a fifth reference signal Vref5, and sends the control signal S5 to the switchable bidirectional regulator 31, wherein the third error amplifier circuit 38 for example can receive information of the voltage at the first common node N31 by the second voltage sensing unit 322. The second voltage sensing unit 322 sends the sensing result to the third error amplifier circuit 38, and the third error amplifier circuit 38 generates a fifth control signal S5 according to comparison between the voltage sensing result and the fifth reference signal Vref5. The third error amplifier circuit 38 and the charge control unit 32 can receive information from the same second voltage sensing unit 322.

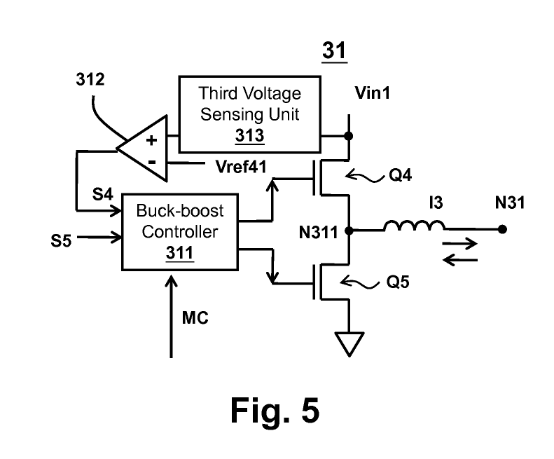

FIG. 5 shows another embodiment of the switchable bidirectional regulator 31. In this embodiment, the switchable bidirectional regulator 31 includes a buck-boost controller 311, a fifth error amplifier 312, an upper transistor switch Q4, a lower transistor switch Q5, and an inductor 13. The upper transistor switch Q4 has one end which is coupled to the external terminal Vin1, and another end which is coupled to the lower transistor switch Q5 through a third common node N311 (also named switch node). The upper transistor switch Q4 is coupled to the first common node N31 through the inductor 13, wherein the switchable bidirectional regulator 311 controls a buck or boost voltage conversion operation by turning on/off the upper transistor switch Q4 and the lower transistor switch Q5 according to the control signals S4 and S5. The switchable bidirectional regulator 311 decides to operate for a buck voltage conversion or a boost voltage conversion according to a mode control signal MC, wherein the model control signal MC can be generated in a way as described in the aforementioned embodiment. The buck-boost controller 311 can be a pulse width modulation controller or pulse frequency modulation controller.

The function of the aforementioned control loop is: determining whether the buck voltage conversion reaches the regulated target value according to the voltage at the first common node N31, and determining whether the boost voltage conversion reaches the regulated target value according to the voltage at the external terminal.

Referring to the embodiment shown in FIG. 2, although the voltage information at the first common node N21 is not fed back to the switchable bidirectional regulator 21, because the power transistor Q is under control, and the voltage at the first common node N21, the voltage at the second common node N22, and the relation in between are all under control, the voltage at the first common node N21 is still under control and regulated.

Referring to the embodiment shown in FIG. 4, if it is not required to charge the battery Vbat, the power transistor Q3 and the charge control unit 32 can be omitted; the third error amplifier circuit 38 can be directly coupled to the first common node N31, or it still receives information of the voltage at the first common node N31 by the second voltage sensing unit 322.

The present invention has been described in considerable detail with reference to certain preferred embodiments thereof. It should be understood that the description is for illustrative purpose, not for limiting the scope of the present invention. Those skilled in this art can readily conceive variations and modifications within the spirit of the present invention. For example, each external terminal or common node can be further coupled to a capacitor to stabilize its voltage level; a circuit or device which does not affect the primary function of the circuit can be inserted between two circuit or devices shown to be in direct connection in the figures. For another example, the voltage sensing unit is not a necessarily required and can be omitted; in this case the error amplifier can be directly coupled to the voltage sensing node. The current sensing unit and its connection is not limited to the embodiments shown in figures, either. The description “generating a control signal according to a voltage and a reference signal” intends to include the situation wherein the inputs of the error amplifier are directly coupled to the voltage and the reference signal, and the situation wherein the inputs of the error amplifier are indirectly coupled to the voltage and the reference signal. An embodiment or a claim of the present invention does not need to achieve all the objectives or advantages of the present invention. The title and abstract are provided for assisting searches but not for limiting the scope of the present invention.

What is claimed is:

1. A power supply circuit, comprising:
a plurality of switchable bidirectional regulators, respectively coupled between a first common node and a plurality of external terminals, each external terminal having a switchable connection selectively electrically connectable to a external power source for receiving power supply from the external power source or to an external device for charging the external device, wherein each switchable bidirectional regulator includes:
an upper power transistor switch, coupled to the external terminal;
a lower power transistor switch, coupled to the upper power transistor switch at a switch node;
an inductor, having one terminal coupled to the upper power transistor switch and the lower power transistor switch at the switch node, and the other terminal coupled to the first common node; and
a buck-boost controller, for controlling operations of the upper power transistor switch and the lower power transistor switch to perform either buck or boost voltage conversion, wherein the buck-boost controller receives a mode control signal which determines whether the switchable bidirectional regulator performs buck voltage conversion from the external terminal to the first common node or performs boost voltage conversion from the first common node to the external terminal.

2. The power supply circuit of claim 1, wherein the switchable bidirectional regulator further includes a current sinking and sourcing judgment circuit for testing whether current can be drawn from the external terminal to generate the mode control signal determining whether the switchable bidirectional regulator performs buck voltage conversion or performs boost voltage.

3. The power supply circuit of claim 1, further comprising:
a second common node;
a power transistor, coupled between the first common node and the second common node; and
a charge control unit, for controlling the power transistor to charge the second common node from the first common node.

4. The power supply circuit of claim 3, wherein the charge control unit controls the charging to the second common node according to a voltage at the first common node.

5. The power supply circuit of claim 3, wherein the charge control unit controls the charging to the second common node according to a voltage at the first common node, a voltage at the second common node, and a current through the power transistor.

6. The power supply circuit of claim 1, wherein the switchable bidirectional regulator includes an error amplifier for generating a control signal according to a voltage at the external terminal and a reference signal, and the buck-boost controller operates according to the control signal when the switchable bidirectional regulator performs boost voltage conversion from the first common node to the external terminal.

7. The power supply circuit of claim 1, further comprising a first error amplifier for generating a first control signal according to a voltage at the first common node and a reference signal, wherein the buck-boost controller operates according to the first control signal when the switchable bidirectional regulator performs buck voltage conversion from the external terminal to the first common node.

8. The power supply circuit of claim 7, wherein the switchable bidirectional regulator includes a second error amplifier for generating a second control signal according to a voltage at the external terminal and a second reference signal, and the buck-boost controller operates according to the second control signal when the switchable bidirectional regulator performs boost voltage conversion from the first common node to the external terminal.

9. The power supply circuit of claim 3, further comprising:
a first error amplifier, for generating a first control signal according to a current through the power transistor and a first reference signal; and
a second error amplifier, for generating a second control signal according to a voltage at the second common node and a second reference signal,
wherein the buck-boost controller operates according to the first control signal and the second control signal when the switchable bidirectional regulator performs buck voltage conversion from the external terminal to the first common node.

10. The power supply circuit of claim 9, wherein the switchable bidirectional regulator includes a third error amplifier for generating a third control signal according to a voltage at the external terminal and a third reference signal, and the buck-boost controller operates according to the third control signal when the switchable bidirectional regulator performs boost voltage conversion from the first common node to the external terminal.

11. The power supply circuit of claim 1, wherein at least one external terminal is coupled to an external power source, and at least another external terminal is coupled to an external device.
